(19) United States
(12) Patent Application Publication
(10) Pub. No.: US 2013/0259412 A1
(43) Pub. Date: Oct. 3, 2013

(54) SPINDLE MOTOR

(71) Applicant: Satoru SODEOKA, Suwon (KR)

(72) Inventor: Satoru SODEOKA, Suwon (KR)

(73) Assignee: SAMSUNG ELECTRO-MECHANICS CO., LTD., Suwon (KR)

(21) Appl. No.: 13/611,176

(22) Filed: Sep. 12, 2012

(30) Foreign Application Priority Data
Apr. 3, 2012 (KR) 10-2012-0034368

(51) Int. Cl. H02K 7/08; F16C 32/06

(52) U.S. Cl. 384/112

(57) ABSTRACT

A spindle motor includes a base part including a base member and a lower thrust member fixed to the base member; a shaft having a lower end portion fixed to the base part and including a sealing groove formed in an outer peripheral surface thereof to form a liquid-vapor interface; an upper thrust member fixed to an upper end portion of the shaft; a rotating member including a sleeve part between the upper and lower thrust members; and an upper case fixing the upper end portion of the shaft. The shaft includes a connection groove recessed downwardly from an upper surface thereof and a communication hole for connecting the connection groove to the sealing groove. At least one of the shaft and a lower surface of the upper case has a connection part for connecting the connection groove to a space between the upper case and the upper thrust member.

### CROSS-REFERENCE TO RELATED APPLICATIONS

This application claims the priority of Korean Patent Application No. 10-2012-0034368 filed on Apr. 3, 2012, in the Korean Intellectual Property Office, the disclosure of which is incorporated herein by reference.

### BACKGROUND OF THE INVENTION

1. Field of the Invention

The present invention relates to a spindle motor.

2. Description of the Related Art

An information recording and reproducing device such as a hard disk drive, or the like, may have a fixed shaft type spindle motor, in which a shaft having high resistance to vibrations is fixed to a case of the hard disk drive, mounted therein.

That is, the spindle motor mounted in the hard disk drive may have a structure in which the shaft is fixedly installed in order to prevent recorded information from being damaged and becoming unrecoverable or unreadable due to an external impact.

Meanwhile, since it is demanded that a spindle motor used for a hard disk drive have a high level of reliability, it is necessary to stably maintain an amount of lubricating fluid contained in a hydrodynamic bearing assembly including a fixed-type shaft.

To this end, a structure by which the lubricating fluid contained in the hydrodynamic bearing assembly can be separately contained in upper and lower portions thereof may be used.

In addition, in order to reduce manufacturing costs, a sleeve and a rotor hub may be formed integrally with each other.

However, in order to form the sleeve and the rotor hub integrally with each other while simultaneously using a structure capable of stably maintaining an amount of the lubricating fluid by separately containing the lubricating fluid in the upper and lower portions of the hydrodynamic bearing assembly as described above, the development of a new structure has been demanded.

That is, it is difficult to form a structure capable of separately containing the lubricating fluid in the upper and lower portions of the hydrodynamic bearing assembly while allowing the sleeve and the rotor hub to be formed integrally with each other.

In other words, the development of a structure capable of separately containing the lubricating fluid in the upper and lower portions of the hydrodynamic bearing assembly while allowing the sleeve and the rotor hub to be formed integrally with each other has been urgently demanded.

### RELATED ART DOCUMENT

(Patent Document 1) Korean Patent Laid-open Publication No. 2004-75303

### SUMMARY OF THE INVENTION

An aspect of the present invention provides a spindle motor capable of reducing an amount of evaporated lubricating fluid.

According to an aspect of the present invention, there is provided a spindle motor including: a base part including a base member and a lower thrust member fixed to the base member; a shaft having a lower end portion fixed to the base part and including a sealing groove formed in an outer peripheral surface thereof in order to form a liquid-vapor interface; an upper thrust member fixed to an upper end portion of the shaft; a rotating member including a sleeve part disposed between the upper and lower thrust members; and an upper case fixing the upper end portion of the shaft, wherein the shaft includes a connection groove recessed downwardly from an upper surface thereof and a communication hole formed therein in order to connect the connection groove and the sealing groove to each other, and at least one of the shaft and a lower surface of the upper case has a connection part for connecting the connection groove and a space between the upper case and the upper thrust member to each other.

The sealing groove may have upper and lower inclination parts provided in order to form liquid-vapor interfaces.

The sleeve part may have an upper inclination surface provided in order to form a liquid-vapor interface together with the upper thrust member.

The sleeve part may have a lower inclination surface provided in order to form a liquid-vapor interface together with the lower thrust member.

The shaft and the upper thrust member may form, together with an upper end portion of the sleeve part, an upper bearing clearance containing a lubricating fluid. The shaft and the lower thrust member may form, together with a lower end portion of the sleeve part, a lower bearing clearance containing the lubricating fluid. The lubricating fluid may be separately contained in the upper and lower bearing clearances.

The upper thrust member may include a disk part having a hollow disk shape and an extension wall part extended from an edge of the disk part.

The rotating member may have an insertion groove in which the extension wall part is insertedly disposed.

The spindle motor may further include an installation member fixedly mounted on an outer peripheral surface of an installation part of the base member and having a stator core installed thereon.

The connection groove may be provided with a screw thread to which a screw for fixing the shaft to the upper case is coupled.

The connection part may be a groove formed in at least one of the upper surface of the shaft and the lower surface of the upper case.

The connection groove may be recessed from a lower surface of the shaft in an upper axial direction and has a lower end portion closed by a sealing member.

The upper end portion of the shaft may be provided with an insertion coupling part insertedly mounted in the upper case, and the connection part may be a hole formed to be disposed below the insertion coupling part.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention;

FIG. 2 is an enlarged view showing part X of FIG. 1;

FIG. 3 is a partially cut-away perspective view showing a shaft included in the spindle motor according to the embodiment of the present invention;

FIG. 4 is a view describing an operation of the spindle motor according to the embodiment of the present invention;

FIG. 5 is a schematic cross-sectional view showing a spindle motor according to another embodiment of the present invention;

FIG. 6 is a partially cut-away perspective view showing a shaft included in the spindle motor according to another embodiment of the present invention; and

FIG. 7 is a view describing an operation of the spindle motor according to another embodiment of the present invention.

### DETAILED DESCRIPTION OF THE EMBODIMENTS

Embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, but those are construed as being included in the scope of the present invention.

Further, when it is determined that a detailed description of the known art related to the present invention may obscure from the gist of the present invention, a detailed description thereof will be omitted.

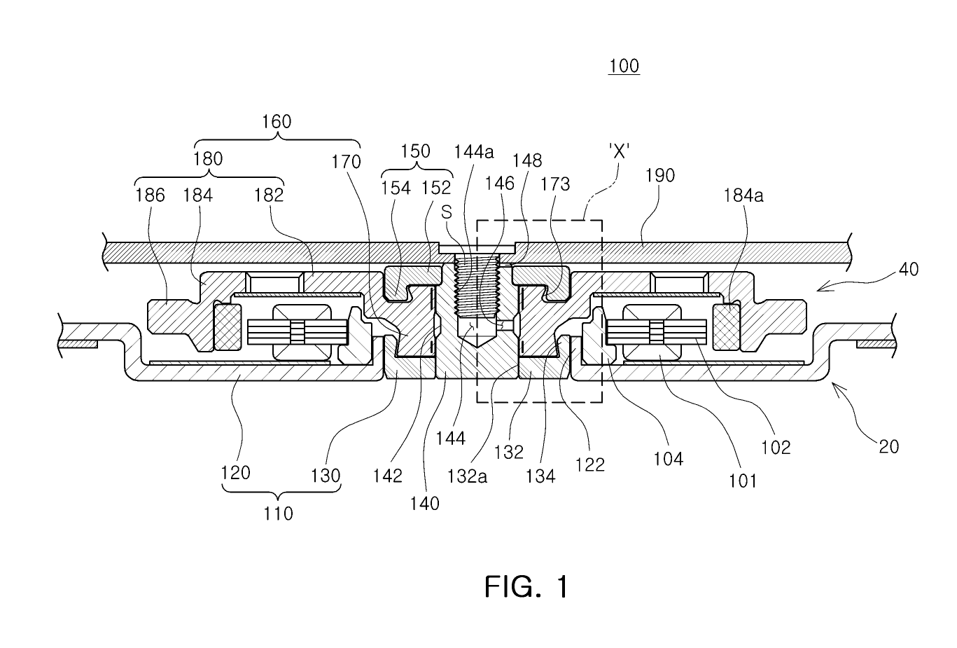

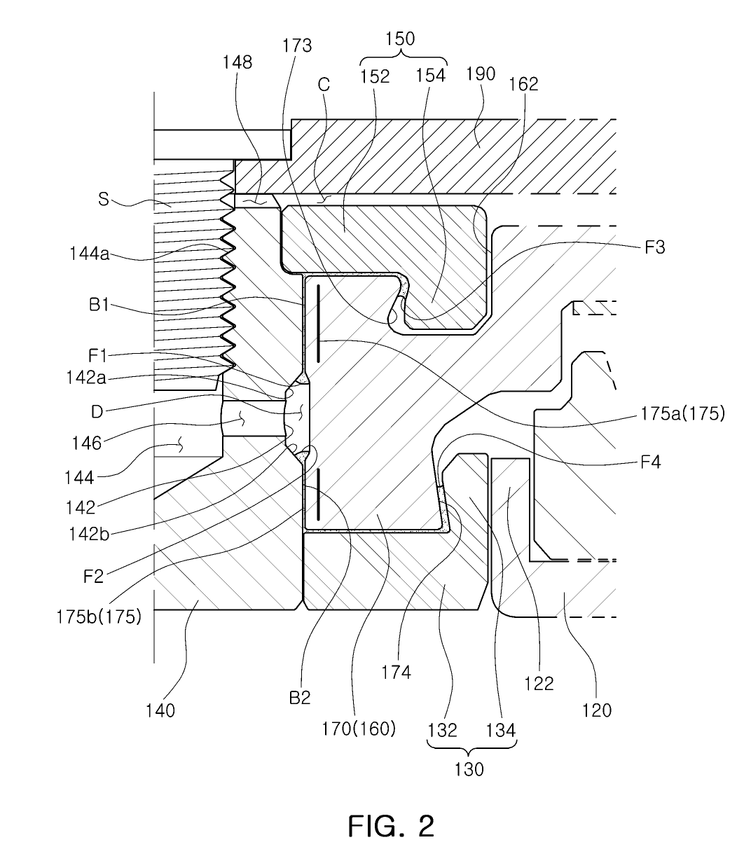

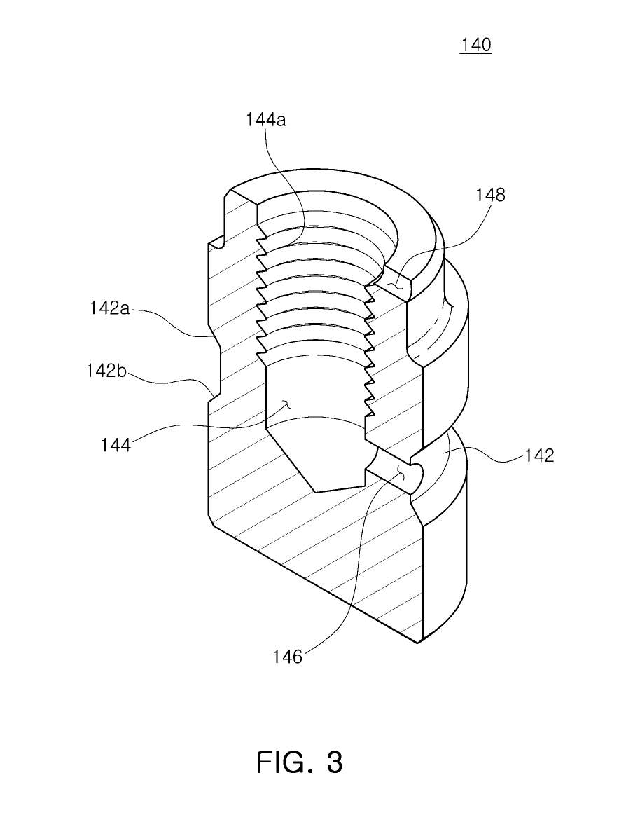

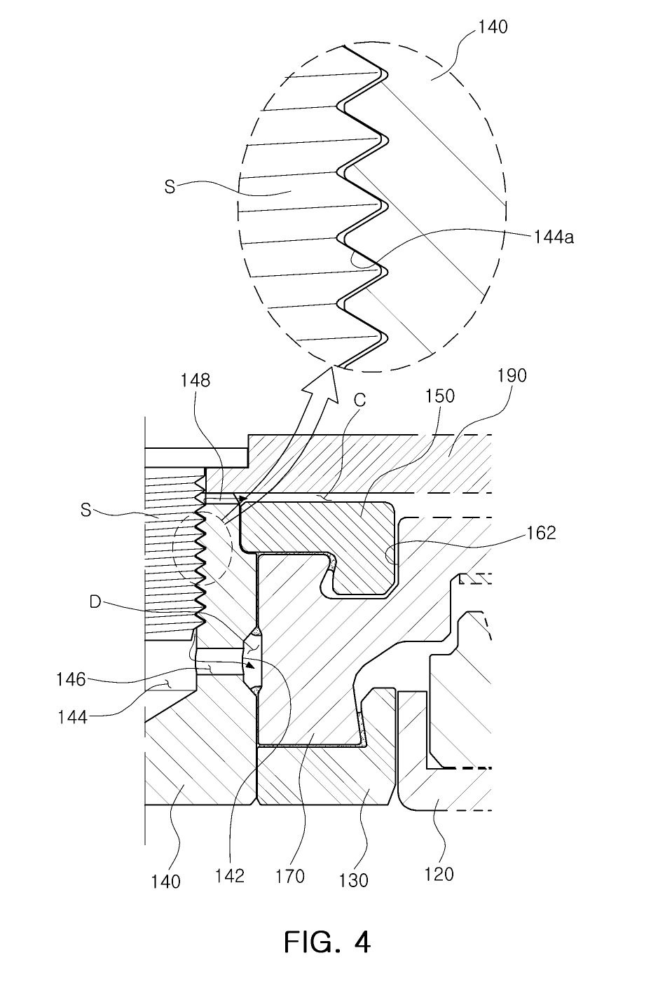

FIG. 1 is a schematic cross-sectional view showing a spindle motor according to an embodiment of the present invention; FIG. 2 is an enlarged view showing part X of FIG. 1; FIG. 3 is a partially cut-away perspective view showing a shaft included in the spindle motor according to the embodiment of the present invention; and FIG. 4 is a view describing an operation of the spindle motor according to the embodiment of the present invention.

Referring to FIGS. 1 through 4, a spindle motor 100 according to the embodiment of the present invention may include a base part 110 including a base member 120 and a lower thrust member 130, a shaft 140, an upper thrust member 150, a rotating member 160 including a sleeve part 170 and a rotor hub part 180, and an upper case 190, by way of example.

Meanwhile, the spindle motor 100 according to the embodiment of the present invention may be a motor used in an information recording and reproducing device such as a hard disk drive, or the like.

In addition, the spindle motor 100 according to the embodiment of the present invention may mainly be configured of a stator 20 and a rotor 40.

The stator 20, referring to all fixed members with the exception of rotating members, may include the base part 110 including the base member 120 and the lower thrust member 130, the shaft 140, the upper thrust plate 150, the upper case 190, and the like.

In addition, the rotor 40, referring to all members rotating around the shaft 140, may include the rotating member 160, and the like.

Here, terms with respect to directions will be defined. As viewed in FIG. 1, an axial direction refers to a vertical direction, that is, a direction from a lower portion of the shaft 140 toward an upper portion thereof or a direction from the upper portion of the shaft 140 toward the lower portion thereof, and a radial direction refers to a horizontal direction, that is, a direction from the shaft 140 toward an outer peripheral surface of the rotating member 160 or from the outer peripheral surface of the rotating member 160 toward shaft 140.

In addition, a circumferential direction refers to a rotation direction along the outer peripheral direction of the rotating member 160.

The base part 110 may include the base member 120 and the lower thrust member 130 fixed to the base member 120. Meanwhile, the base part 110 may be a fixed member included in the stator 20 rotatably supporting the rotor 40.

The base member 120 may include an installation part 122 extended in an upward axial direction.

The base member 120 may be manufactured by press processing. That is, the base member 120 may be formed by disposing a cold rolled steel sheet (SPCC, SPCE, or the like), a hot rolled steel sheet, a light weight alloy steel sheet made of a stainless steel, a boron alloy, a magnesium alloy, a boron-magnesium alloy or the like, in a press mold and applying a predetermined amount of pressing pressure thereto.

However, the base member 120 is not limited to being formed by press processing, but may be formed of aluminum (Al) by die-casting.

In addition, the installation part 122 may include an installation member 104 mounted on an outer peripheral surface thereof, and the installation member 104 has a stator core 102 installed thereon. Further, the installation member 104 may be fixed to the outer peripheral surface of the installation part 122 by using an adhesive and/or welding.

The lower thrust member 130 may be fixedly attached to the base member 120. That is, the lower thrust member 130 may be insertedly installed in the installation part 122. More specifically, an outer peripheral surface of the lower thrust member 130 may be bonded to an inner peripheral surface of the installation part 122.

Meanwhile, the lower thrust member 130 may include a disk shaped body part 132 having an inner surface bonded to the shaft 140 and an outer surface fixedly attached to the base member 120 and a protrusion part 134 extended from an edge of the body part 132 in the upward axial direction.

That is, the lower thrust member 130 may have a cup shape having a hollow part and may have an ‘L’-shaped cross section.

In addition, the body part 132 may be formed to have an installation hole 132a for installing the shaft 140 therein, and a low end portion of the shaft 140 may be insertedly mounted in the installation hole 132a.

In addition, the lower thrust member 130 may be included, together with the base member 120, in the fixed member, that is, the stator 20.

Meanwhile, the outer peripheral surface of the lower thrust member 130 may be bonded to an inner surface of the base member 120 by an adhesive and/or welding. In other words, the outer peripheral surface of the lower thrust member 130 may be fixedly bonded to an inner surface of the installation part 122 of the base member 120.

In addition, a thrust dynamic pressure groove (not shown) for generating thrust fluid dynamic pressure may be formed in at least one of an upper surface of the lower thrust member 130 and a lower surface of the sleeve part 170.

Further, the lower thrust member 130 may also serve as a sealing member for preventing lubricating fluid from being leaked.

The shaft 140, a fixed member configuring the stator 20, together with the above-mentioned base part 110, may have a lower end portion fixedly attached to the base part 110 and include a sealing groove 142 formed in an outer peripheral surface thereof in order to form a liquid-vapor interface.

That is, the lower end portion of the shaft 140 may be inserted into the installation hole 132a formed in the body part 132 of the lower thrust member 130. In addition, the lower end portion of the shaft 140 may be bonded to an inner surface of the body part 132 by an adhesive and/or welding. Therefore, the shaft 140 may be fixed.

Further, although the case in which the shaft 140 is fixedly attached to the lower thrust member 130 is described in the present embodiment, the present invention is not limited thereto. That is, the shaft 140 may also be fixedly attached to the base member 120.

In addition, the sealing groove 142 may have upper and lower inclination parts 142a and 142b provided in order to form the liquid-vapor interfaces as shown in more detail in FIG. 2. In addition, the sealing groove 142 may be depressed inwardly from the outer peripheral surface of the shaft to thereby separate a lubricating fluid into two parts to be contained in bearing clearances B1 and B2. In other words, interfaces (that is, liquid-vapor interfaces) between the lubricating fluid and air may be formed in spaces formed by the upper and lower inclination parts 142a and 142b of the sealing groove 142 and an inner peripheral surface of the sleeve part 170.

Therefore, the lubricating fluid may be separately contained in the upper and lower portions of the sealing groove.

Meanwhile, although the case in which the sealing groove 142 is formed in the shaft 140 is described in the present embodiment, the present invention is not limited thereto. That is, the sealing groove 142 may be formed in the sleeve part 170.

In addition, the shaft 140 may include a connection groove 144 recessed downwardly from an upper surface thereof. That is, the connection groove 144 may be formed with a screw thread 144a to which a screw S for fixing the shaft 140 to the upper case 190 is coupled.

Meanwhile, the shaft 140 may include a communication hole 146 formed therein in order to connect the connection groove 144 and the sealing groove 142 to each other. That is, the communication hole 146 may connect the connection groove 144 and the sealing groove 142 to each other so that pressure in a space D formed by the sealing groove 142 and the sleeve part 170 may be equal to atmospheric pressure.

In addition, the shaft 140 may include a connection part 148 formed therein in order to connect the connection groove 144 and the outside to each other. That is, the connection part 148 for connecting a space C formed by the upper thrust member 150 and the upper case 190 to the connection groove 144 at the time of installation of the upper case 190 may be formed in the shaft 140.

Meanwhile, the connection part 148 may be a groove formed at an edge of an upper surface of the shaft 140.

Although the case in which the connection part 148 is formed in the shaft 140 is described in the present embodiment, the present invention is not limited thereto. That is, the connection part 148 may also be formed in the upper case 190 or may be formed in both of the upper case 190 and the shaft 140.

The upper thrust member 150, a fixed member configuring the stator 20, together with the base part 110 and the shaft 140, may be fixedly attached to an upper end portion of the shaft 140. In addition, the upper thrust member 150 may include a disk part 152 having a hollow disk shape and an extension wall part 154 extended from an edge of the disk part 152.

Further, an inner peripheral surface of the extension wall part 154 may be disposed to face an upper end portion of the sleeve part 150. A detailed description thereof will be provided below.

Meanwhile, a thrust dynamic pressure groove (not shown) for generating thrust dynamic pressure may be formed in at least one of a lower surface of the upper thrust member 150 and an upper surface of the sleeve part 170 disposed to face the lower surface of the upper thrust member 150.

Further, the upper thrust member 150 may also serve as a sealing member preventing the lubricating fluid from being leaked upwardly.

The rotating member 160, a rotating member configuring the rotor 40, may include the sleeve part 170 disposed between the upper thrust member 150 and the lower thrust member 130.

In addition, the rotating member 160 may include the above-mentioned sleeve part 170 and the rotor hub part 180 on which a disk is mounted. Further, the sleeve part 170 and the rotor hub part 180 may be formed integrally with each other.

Further, the rotating member 160 may be provided with an insertion groove 162 in which the extension wall part 154 of the upper thrust member 150 is insertedly disposed.

Meanwhile, the sleeve part 170 may be provided with a shaft hole 172 into which the shaft 140 is inserted. Further, in the case in which the rotating member 160 is attached to the shaft 140, the inner peripheral surface of the sleeve part 170 and the outer peripheral surface of the shaft 140 may be disposed to be spaced apart from each other by a predetermined interval to form the bearing clearances B1 and B2 therebetween, as shown in FIG. 2.

These bearing clearances B1 and B2 may be filled with the lubricating fluid.

Here, describing the bearing clearances B1 and B2 in more detail, the bearing clearances B1 and B2 may be configured of an upper bearing clearance B1 and a lower bearing clearance B1. In addition, the upper bearing clearance B1 refers to a clearance formed by the upper end portion of the shaft 140 and the upper end portion of the sleeve part 170 and a clearance formed by the upper end portion of the sleeve part 170 and the upper thrust member 150.

Further, the lower bearing clearance B2 refers to a clearance formed by the lower end portion of the shaft 140 and a lower end portion of the sleeve part 170 and a clearance formed by the lower end portion of the sleeve part 170 and the lower thrust member 130.

Here, describing the sealing groove 142, the sealing groove 142 may serve to form the interfaces between the lubricating fluid contained in the above-mentioned bearing clearances B1 and B2, that is, the upper bearing clearance B1 and the lower bearing clearance B2 and air.

In other words, as shown in FIG. 2, a first liquid-vapor interface F1, that is, the interface between the lubricating fluid contained in the upper bearing clearance B1 and the air may be formed in the upper portion of the sealing groove 142, that is, the upper inclination part 142a.

In addition, a second liquid-vapor interface F2, that is, the interface between the lubricating fluid contained in the lower bearing clearance B2 and the air may be formed in the lower portion of the sealing groove 142, that is, the lower inclination part 142b.

That is, the sealing groove 142 may have the upper and lower inclination parts 142a and 142b formed in the upper and lower portions thereof so that the first and second liquid-vapor interfaces F1 and F2 may be formed by a capillary phenomenon.

Meanwhile, the communication hole 146 allowing the space formed by the sealing groove 142 and the sleeve part 170 to be in communication with the outside may be formed in the shaft 140. That is, the communication hole 146 allowing pressure in the space D formed by the sealing groove 142 and the inner peripheral surface of the sleeve part 170 to be equal to pressure in the space C formed by the upper thrust member 150 and the upper case 190 may be formed in the shaft 140.

Here, a connection path between the outside and the sealing groove 142 will be described in more detail.

The sealing groove 142 may be connected to the connection groove 144 through the communication hole 146. Further, in the case in which the screw S is coupled to the connection groove 144, the screw S and the screw thread 144a of the connection groove 144 may be spaced apart from each other by a predetermined interval to serve as a connection path with the outside.

In addition, since the connection part 148 is formed at the edge of the upper surface of the shaft 140, the connection groove 144 and the outside may be connected to each other by the connection part 148 even at the time of the installation of the upper case 190.

Since the outside and the sealing groove 142 are in communication with each other through the above-mentioned connection path, the pressure in the space D formed by the sealing groove 142 and the inner peripheral surface of the sleeve part 170 and the pressure in the space C formed by the upper thrust member 150 and the upper case 190 may be maintained to be equal to each other.

Meanwhile, the sleeve part 170 may have an upper inclination surface 173 formed at the upper end portion thereof so as to form a liquid-vapor interface together with the extension wall part 154 of the upper thrust member 150, wherein the upper inclination surface 173 has an outer diameter larger in an upper portion thereof than in a lower portion thereof.

In other words, the upper inclination surface 173 having the outer diameter larger in the upper portion thereof than in the lower portion thereof may be formed at the upper end portion of the sleeve part 170 so that a third liquid-vapor interface F3 may be formed in a space between an outer peripheral surface of the sleeve part 170 and the inner peripheral surface of the extension wall part 154.

Therefore, the lubricating fluid contained in the upper bearing clearance B1 forms the first and third liquid-vapor interfaces F1 and F3.

In addition, the rotor hub part 180 may be extended from an upper end portion of the outer peripheral surface of the sleeve part 170.

Meanwhile, the sleeve part 170 may have a lower inclination surface 174 formed at a lower end portion of the outer peripheral surface thereof so as to form a liquid-vapor interface together with the protrusion part 134 of the lower thrust member 130, wherein the lower inclination surface 174 is inclined upwardly in the inner radial direction.

That is, the lower inclination surface 174 may be formed at the lower end portion of the sleeve part 170 to be inclined upwardly in the inner radial direction so that a fourth liquid-vapor interface F4 may be formed in a space between the outer peripheral surface of the sleeve part 170 and the protrusion part 134 of the lower thrust member 130.

As described above, since the fourth liquid-vapor interface F4 is formed in the space between the lower end portion of the sleeve part 170 and the protrusion part 134, the lubricating fluid contained in the lower bearing clearance B2 may form the second and fourth liquid-vapor interfaces F2 and F4.

Meanwhile, although the case in which the upper and lower inclination surfaces 173 and 174 are formed in the sleeve part 170 in order to form the third and fourth liquid-vapor interfaces F3 and F4 is described in the present embodiment, the present invention is not limited thereto. That is, the upper and lower inclination surfaces 173 and 174 for forming the third and fourth liquid-vapor interfaces F3 and F4 may also be formed in the upper and lower thrust members 130 and 150 disposed to face the outer peripheral surface of the sleeve part 170.

In addition, the sleeve part 170 may include a dynamic pressure groove 175 formed in the inner surface thereof, and the dynamic pressure groove 175 generates fluid dynamic pressure through the lubricating fluid contained in the bearing clearance B1 and B2 at the time of rotation of the sleeve part 170. In addition, the dynamic pressure groove may include upper and lower dynamic pressure grooves 175a and 175b.

However, the dynamic pressure groove 175 is not limited to being formed in the inner surface of the sleeve part 170, but may also be formed in the outer peripheral surface of the shaft 140.

Meanwhile, the third liquid-vapor interface F3 may be biased toward the upper inclination surface 173 of the sleeve part 170 at the time of rotation of the rotating member 160. That is, since the upper thrust member 150 is the fixed member and the sleeve part 170 rotates, the third liquid-vapor interface F3 may be biased toward the sleeve part 170 by centrifugal force.

Therefore, scattering of the lubricating fluid due to the centrifugal force may be suppressed.

In addition, the extension wall part 154 of the upper thrust member 150 may be insertedly disposed in the insertion groove 162 formed in the rotating member 160. Therefore, an outer peripheral surface of the extension wall part 154 and a sidewall of the insertion groove 162 of the rotating member 160 disposed to face the outer peripheral surface of the extension wall part 154 may form a labyrinth seal. That is, the extension wall part 154 of the upper thrust member 150 may be insertedly disposed in the insertion groove 162 formed in the rotating member 160 so as to form the labyrinth seal capable of suppressing air contained in the evaporated lubricating fluid from moving outwardly.

Therefore, a phenomenon of insufficiency of the lubricating fluid due to the evaporation thereof may be suppressed.

The rotor hub part 180 may be extended from the upper end portion of the sleeve part 170 in the radial direction. In addition, the rotor hub part 180 may include a rotor hub part body 182 having a disk shape, a magnet mounting part 184 extended from an edge of the rotor hub part body 182 and having a driving magnet 184a mounted on an inner surface thereof, and a disk seat part 186 extended from a distal end of the magnet mounting part 184 in the outer radial direction.

Meanwhile, the driving magnet 184a may have an annular ring shape and be a permanent magnet generating a magnetic field having a predetermined strength by alternately magnetizing an N pole and an S pole in the circumferential direction.

In addition, the driving magnet 184a may be disposed to face a front end of the stator core 102 having a coil 101 wound therearound and serve to generate driving force through electromagnetic interaction with the stator core 102 having the coil 101 wound therearound so that the rotating member 160 may rotate.

That is, when power is supplied to the coil 101, driving force capable of rotating the rotating member 160 may be generated by the electromagnetic interaction between the stator core 102 having the coil 101 wound therearound and the driving magnet 184a disposed to face the stator core 102, such that the rotating member 160 may rotate based on the shaft 140.

The upper case 190 may serve to fix the upper end portion of the shaft 140. In addition, although not shown in detail, the upper case 190 may be assembled with the base member 120 so as to form a closed space together therewith. Further, the upper end portion of the shaft 140 may be fixedly attached to the upper case 190 through the screw S.

As described above, since a connection path with the outside may be narrow and long, an amount of evaporated lubricating fluid may be reduced. That is, since the connection path connecting the space D formed by the sealing groove 142 and the sleeve part 170 to the outside may be narrow and long, the amount of evaporated lubricating fluid may be reduced.

In addition, manufacturing costs of the spindle motor may be reduced through the rotating member 160 in which the rotor hub part 180 and the sleeve part 170 are formed integrally with each other.

Hereinafter, a spindle motor according to another embodiment of the present invention will be described with reference to the accompanying drawings. However, a detailed description of the same components as those mentioned above will be omitted.

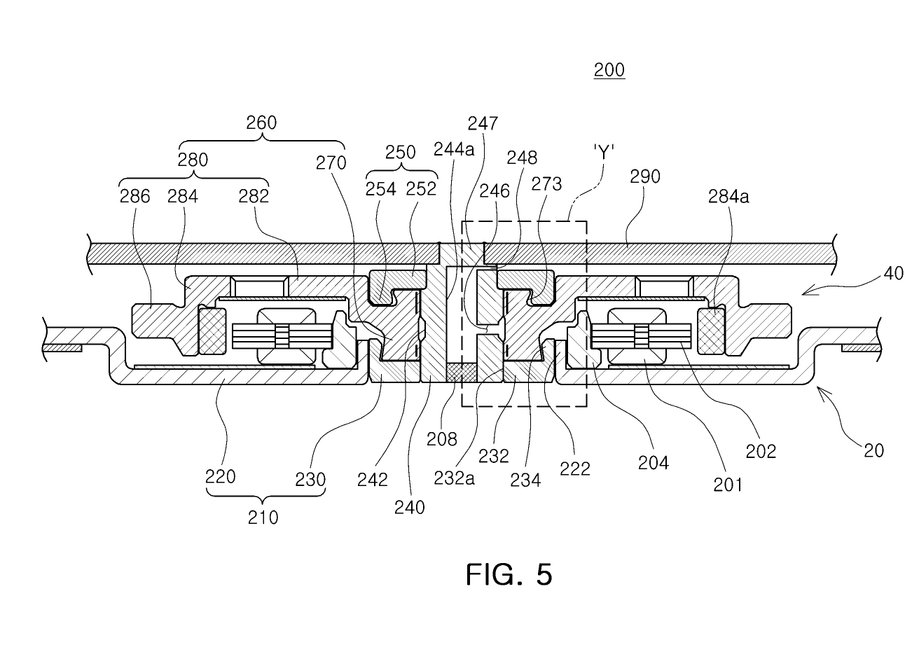

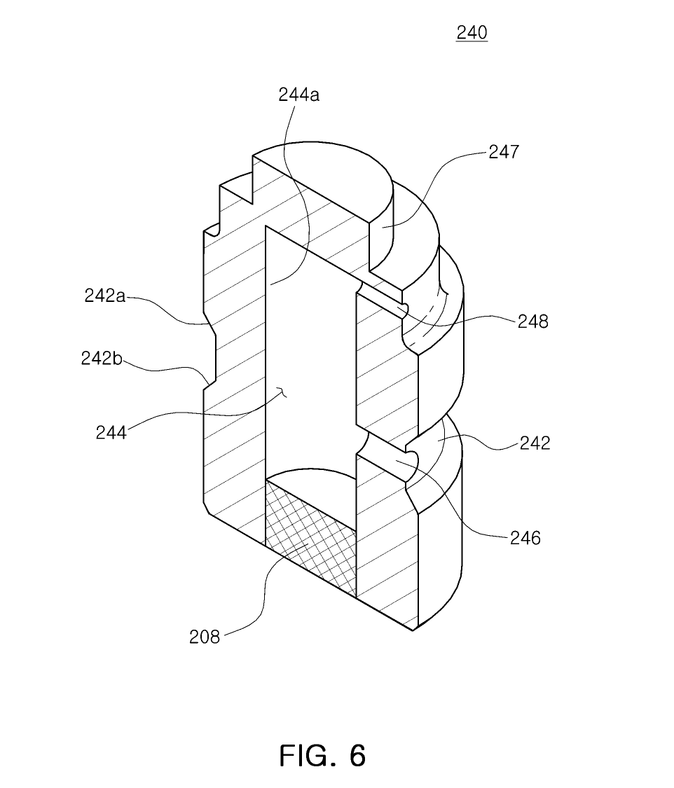

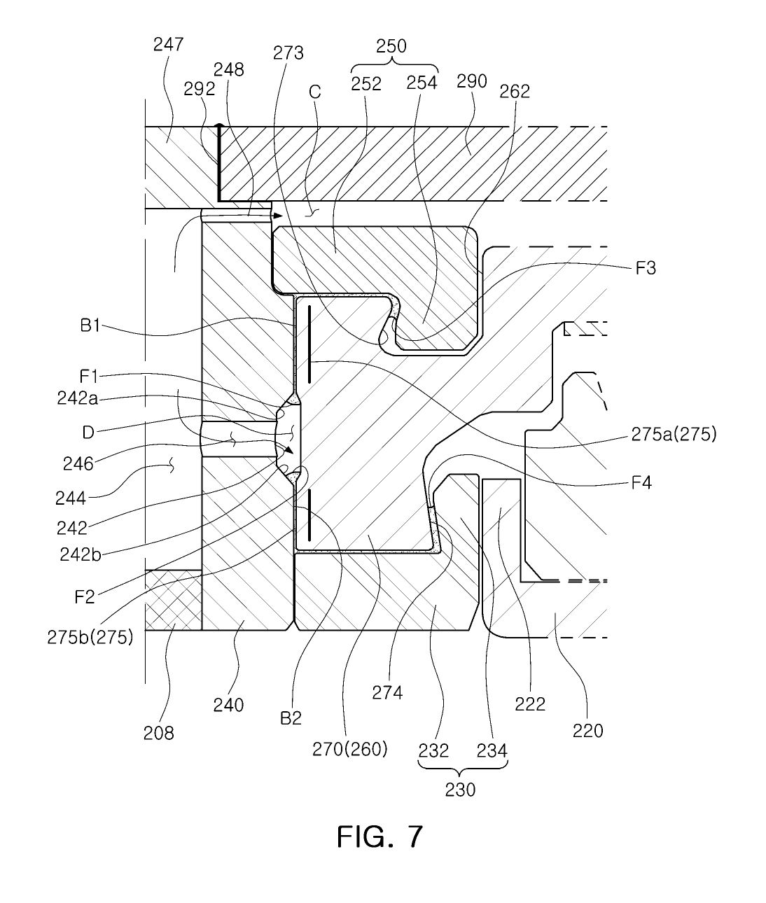

FIG. 5 is a schematic cross-sectional view showing a spindle motor according to another embodiment of the present invention; FIG. 6 is a partially cut-away perspective view showing a shaft included in the spindle motor according to another embodiment of the present invention; and FIG. 7 is a view describing an operation of the spindle motor according to another embodiment of the present invention.

Referring to FIGS. 5 through 7, a spindle motor 200 according to another embodiment of the present invention may include a base part 210 including a base member 220 and a lower thrust member 230, a shaft 240, an upper thrust member 250, a rotating member 260 including a sleeve part 270 and a rotor hub part 280, and an upper case 290.

Meanwhile, since the base part 210 including the base member 220 and the lower thrust member 230, the upper thrust member 250, the rotating member 260 including the sleeve part 270 and the rotor hub part 280, and the upper case 290 included in the spindle motor 200 according to this embodiment of the present invention are equal to the base part 110 including the base member 120 and the lower thrust member 130, the upper thrust member 150, the rotating member 160 including the sleeve part 170 and the rotor hub part 180, and the upper case 190 included in the spindle motor 100 according to the above-described embodiment of the present invention, a detailed description thereof will be omitted.

Hereinafter, the shaft 240 will be described in detail.

The shaft 240, a fixed member configuring the stator 20, together with the above-mentioned base part 210, may have a lower end portion fixedly attached to the base part 210 and include a sealing groove 242 formed in an outer peripheral surface thereof in order to form a liquid-vapor interface.

That is, the lower end portion of the shaft 240 may be inserted into an installation hole 232a formed in a body part 232 of the lower thrust member 230. In addition, the lower end portion of the shaft 240 may be bonded to an inner surface of the body part 232 by an adhesive and/or welding. Therefore, the shaft 240 may be fixed.

Further, although the case in which the shaft 240 is fixedly attached to the lower thrust member 230 is described in the present embodiment, the present invention is not limited thereto. That is, the shaft 240 may also be fixedly attached to the base member 220.

In addition, the sealing groove 242 may include upper and lower inclination parts 242a and 242b formed therein in order to form the liquid-vapor interfaces. In addition, the sealing groove 242 may be depressed inwardly from the outer peripheral surface of the shaft to separate a lubricating fluid into two parts to be contained in bearing clearances B1 and B2. In other words, interfaces (that is, liquid-vapor interfaces) between the lubricating fluid and air may be formed in spaces formed by the upper and lower inclination parts 242a and 242b of the sealing groove 242 and an inner peripheral surface of the sleeve part 270.

Therefore, the lubricating fluid may be separately contained in the upper and lower portions of the sealing groove.

Meanwhile, although the case in which the sealing groove 242 is formed in the shaft 240 is described in the present embodiment, the present invention is not limited thereto. That is, the sealing groove 242 may be formed in the sleeve part 270.

In addition, the shaft 240 may include a connection groove 244 recessed from a lower surface thereof. Further, a lower end portion of the connection groove 244 may be closed by a sealing member 208.

Meanwhile, the shaft 240 may include a communication hole 246 formed therein in order to connect the connection groove 244 and the sealing groove 242 to each other. That is, the communication hole 246 may connect the connection groove 244 and the sealing groove 242 to each other so that pressure in a space D formed by the sealing groove 242 and the sleeve part 270 may be equal to atmospheric pressure.

In addition, an insertion coupling part 247 may be formed on the upper end portion of the shaft 240 to be inserted into the upper case 290 and fixedly installed therein. That is, the insertion coupling part 247 may be inserted into an insertion hole 292 of the upper case 290 and bonded thereto by an adhesive and/or welding. Therefore, the shaft 240 may be fixedly attached to the upper case 290.

In addition, the shaft 240 may include a connection part 248 formed therein in order to connect the connection groove 244 and the outside to each other. That is, the connection part 248 for connecting a space C formed by the upper thrust member 250 and the upper case 290 to the connection groove 244 at the time of installation of the upper case 290 may be formed in the shaft 240.

Meanwhile, the connection part 248 may be a hole formed to be disposed below the insertion coupling part 247 of the shaft 240.

As described above, since a connection path between the sealing groove 242 and the space C between the upper case 290 and the upper thrust member 250 is long, an amount of evaporated lubricating fluid may be reduced.

In addition, manufacturing costs of the spindle motor may be reduced through the rotating member 260 in which the rotor hub part 280 and the sleeve part 270 are formed integrally with each other.

As set forth above, according to embodiments of the present invention, a connection path between a sealing groove and the outside is long, whereby an amount of evaporated lubricating fluid may be reduced.

In addition, manufacturing costs of a spindle motor may be reduced through a rotating member in which a rotor hub part and a sleeve part are formed integrally with each other.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a base part including a base member and a lower thrust member fixed to the base member;
a shaft having a lower end portion fixed to the base part and including a sealing groove formed in an outer peripheral surface thereof in order to form a liquid-vapor interface;
an upper thrust member fixed to an upper end portion of the shaft;
a rotating member including a sleeve part disposed between the upper and lower thrust members; and
an upper case fixing the upper end portion of the shaft,
wherein the shaft includes a connection groove recessed downwardly from an upper surface thereof and a communication hole formed therein in order to connect the connection groove and the sealing groove to each other, and
at least one of the shaft and a lower surface of the upper case has a connection part for connecting the connection groove and a space between the upper case and the upper thrust member to each other.

2. The spindle motor of claim 1, wherein the sealing groove has upper and lower inclination parts provided in order to form liquid-vapor interfaces.

3. The spindle motor of claim 1, wherein the sleeve part has an upper inclination surface provided in order to form a liquid-vapor interface together with the upper thrust member.

4. The spindle motor of claim 1, wherein the sleeve part has a lower inclination surface provided in order to form a liquid-vapor interface together with the lower thrust member.

5. The spindle motor of claim 2, wherein the shaft and the upper thrust member form, together with an upper end portion of the sleeve part, an upper bearing clearance containing a lubricating fluid,
the shaft and the lower thrust member form, together with a lower end portion of the sleeve part, a lower bearing clearance containing the lubricating fluid, and
the lubricating fluid is separately contained in the upper and lower bearing clearances.

6. The spindle motor of claim 1, wherein the upper thrust member includes a disk part having a hollow disk shape and an extension wall part extended from an edge of the disk part.

7. The spindle motor of claim 6, wherein the rotating member has an insertion groove in which the extension wall part is insertedly disposed.

8. The spindle motor of claim 1, further comprising an installation member fixedly mounted on an outer peripheral surface of an installation part of the base member and having a stator core installed thereon.

9. The spindle motor of claim 1, wherein the connection groove is provided with a screw thread to which a screw for fixing the shaft to the upper case is coupled.

10. The spindle motor of claim 9, wherein the connection part is a groove formed in at least one of the upper surface of the shaft and the lower surface of the upper case.

11. The spindle motor of claim 1, wherein the connection groove is recessed from a lower surface of the shaft in an upper axial direction and has a lower end portion closed by a sealing member.

12. The spindle motor of claim 11, wherein the upper end portion of the shaft is provided with an insertion coupling part insertedly mounted in the upper case, and
the connection part is a hole formed to be disposed below the insertion coupling part.
